(19) United States
(12) Patent Application Publication
(10) Pub. No.: US 2015/0332881 A1
(43) Pub. Date: Nov. 19, 2015

(54) ELECTROMECHANICAL FUSE FOR DIFFERENTIAL MOTION SENSING

(71) Applicant: HAMILTON SUNDSTRAND CORPORATION, Windsor Locks, CT (US)

(72) Inventors: Michael Carbone, Rockford, IL (US); Kundan Lal Malik, Rockford, IL (US)

(73) Assignee: HAMILTON SUNDSTRAND CORPORATION, Windsor Locks, CT (US)

(21) Appl. No.: 14/280,716

(22) Filed: May 19, 2014

(51) Int. Cl. H01H 35/00

(52) U.S. Cl. CPC H01H 35/006; H01H 2209/014; H01H 2209/012; H01H 2209/002; H01H 2209/016; H01H 2209/032

(57) ABSTRACT

An electromechanical fuse of a differential motion sensor is provided. The fuse includes at least one thick layer that acts as an insulating envelope of the fuse. A thin layer acts as a conductor of the fuse and is made of a lower-strength material.

### BACKGROUND OF INVENTION

This invention relates, generally, to a differential motion sensor that may be employed with, for example, an actuation system of an aircraft and, more specifically, to an electromechanical fuse thereof.

A differential motion sensor, such as a slat disconnect sensor, uses an electromechanical fuse. The fuse is disposed between two arms of the sensor and carries a low voltage signal that, when interrupted, annunciates a fault to a controller of, for example, an actuation system of an aircraft. The sensor may be in communication with mechanical linkages (e.g., panels of a wing of the aircraft) designed to move together. Upon malfunction of one or more of these panels, the fuse fractures. Existing designs of the fuse define a small cross-section of the fuse, use steel or copper alloys as a conductor for the fuse, and have thin insulating coatings.

If tensile “fracture” load or strength of the fuse is too great, the fuse can drive an adjacent panel and not fracture. Due to normal handling of the sensor during manufacturing, assembly, and installation thereof onto the aircraft and/or thermal stresses of the fuse, insulation of the fuse according to existing designs is prone to such fracturing. More specifically, during such handling, the fuse may be subject to bending about “width” and “height” (thickness) directions thereof, which are primarily resisted by a height of the alloys and insulation in the “height” and “width” directions, respectively. As such, “bending” strengths of the fuse should be maximized to avoid damage thereto during the handling, and thickness of the insulation should be maximized as well to avoid “insulation” failures.

Also, in operation of the sensor, skew of a panel can occur such that the fuse is loaded in tension in a direction perpendicular to “height” and “width” directions of the fuse. Again, the tensile “fracture” strength of the fuse should be minimized to provide maximum sensitivity to such skew.

Accordingly, it is desirable for the tensile “fracture” strength of the fuse to be (maintained) low or minimized to add or even maximize sensitivity (including to panel skew) and reduce dormancy thereof. Yet, it is desirable also for the fuse to be sufficiently durable to survive manufacturing of the sensor and normal handling during assembly and installation thereof onto the aircraft. It is desirable also for the fuse to be (increasingly) resistant to handling, bending, and thermal stresses thereof and its insulation to be increasingly (maximally) thick to minimize “insulation” failures for a same low tensile “fracture” strength. It is desirable also for the fuse to maximize “bending” strengths thereof to avoid handling damage. Thus, it is desirable to provide a fuse of a differential motion sensor having improvements related to tensile “fracture” strength, sensitivity, dormancy, durability, bending and thermal-stress resistance, insulation thickness, and “bending” strengths of the fuse.

### BRIEF DESCRIPTION OF INVENTION

According to a non-limiting embodiment of the invention, an electromechanical fuse of a differential motion sensor is provided. The fuse includes at least one thick layer that acts as an insulating envelope of the fuse. A thin layer acts as a conductor of the fuse and is made of a lower-strength material.

The fuse is a conductive link over-molded with insulation. The link is made of a lower-strength conductive metal, which allows the fuse to possess a larger net section. Also, the fuse carries a low voltage signal, has a minimal tensile “fracture” strength, maximizes its sensitivity (including to panel skew) and “bending” strengths, reduces its dormancy, and is sufficiently durable and resistant to handling, bending and thermal stresses thereof. Furthermore, insulation of the fuse is maximally thick for greater durability while maintaining the same low tensile “fracture” strength. In addition, the fuse can be used in any differential-motion-sensing system. Moreover, the fuse can be used as a discriminator in a larger system since the fuse allows a more sensitive load to be employed, which reduces possibility of a dormant failure occurring.

### BRIEF DESCRIPTION OF DRAWING

The subject matter that is regarded as the invention is particularly pointed out and distinctly claimed in the claims at the conclusion of the specification. The foregoing and other features and advantages of the invention are apparent from the following detailed description taken in conjunction with the accompanying drawing in which:

FIG. 1 is a perspective view of a non-limiting embodiment of a differential motion sensor according to the invention.

FIG. 2 is a perspective view of a non-limiting embodiment of an electromechanical fuse of the differential motion sensor according to the invention illustrated in FIG. 1.

FIG. 3 is a sectional view along line “3-3” of FIG. 2 of the non-limiting embodiment of the electromechanical fuse of the differential motion sensor according to the invention.

FIG. 4 is a chart comparing properties of the non-limiting embodiment of the electromechanical fuse of the differential motion sensor according to the invention illustrated in FIG. 2 with corresponding properties of an existing electromechanical fuse of a differential motion sensor.

### DETAILED DESCRIPTION OF INVENTION

Referring now to the figures, a non-limiting embodiment of an electromechanical fuse of a differential motion sensor according to the invention is shown at 20. Although the fuse 20 is disclosed herein as electromechanical, it should be appreciated that the fuse 20 can be any suitable type of fuse. Furthermore, although the fuse 20 is so disclosed as being implemented for a differential motion sensor of an actuation system of an aircraft, it should be appreciated also that the fuse 20 can be implemented for any suitable differential-motion-sensing system or even any suitable type of sensor.

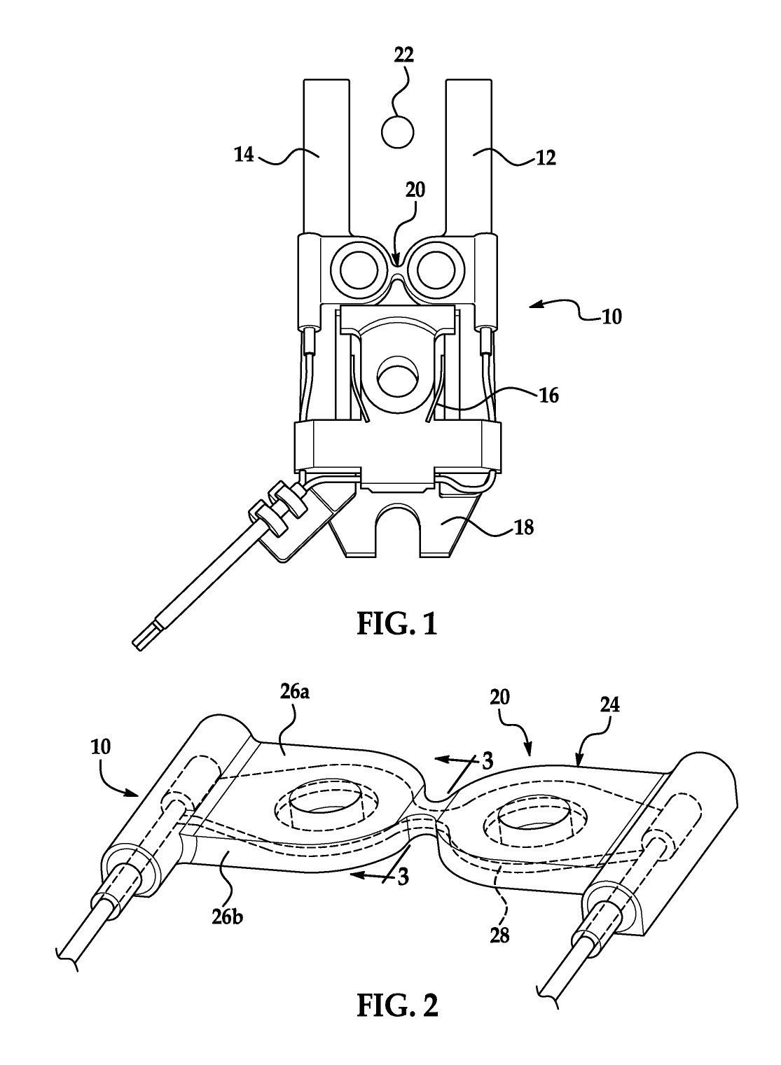

Referring now specifically to FIG. 1, a differential motion sensor with which the fuse 20 can be employed is shown at 10. The sensor 10 includes two separate arms 12, 14 biased away from one another by a separation spring 16. Each arm 12, 14 is hingedly connected to a base 18. The fuse 20 is provided between the arms 12, 14 and connects the arms 12, 14 to each other, holding the arms 12, 14 stationary in normal operation of the sensor 10. The fuse 20 carries a low electrical voltage and, as described below, is configured to fracture under certain conditions. The sensor 10 is configured to be attached to a pair of adjacent panels (not shown) of a wing of an aircraft (not shown) in a manner generally known in the related art.

More specifically, the panels are designed to move together, synchronized in time, during normal operation of the panels (i.e., the panels are configured to move “in sync” with respect to each other). The panels can be wing slats or any two panels designed to move in sync with respect to each other. In a case in which the panels are slats, the panels are generally configured to move in forward and aft directions. If the panels become disconnected from each other, there is relative motion between the panels such that the pin 22 strikes one of the arms 12, 14. In this way, the fuse 20 is loaded, causing fracture of the fuse 20 and detection of the fracture of the panel skew. One of the panels includes a pin 22 that extends into a space defined between the arms 12, 14 and is fixed to the panel. The sensor 10 is fixed to the other panel.

Referring now specifically to FIG. 2, the fuse 20 is substantially “bow-tie” shaped and, thus, defines two halves of the fuse 20 that are substantially symmetrical with each other. The fuse 20 includes an over-molded frame 24 opposing ends of which are operatively connected respectively to other opposed parts of the sensor 10. In turn, the frame 24 defines thick layers 26 that act as an insulating envelope 26 of a conductor 28 (described below) of the fuse 20. In particular, the frame 24 defines a top insulating layer 26a and bottom insulating layer 26b. In an aspect of the non-limiting embodiment, thickness of the insulating layers 26 is about 0.020 inch. However, those having ordinary skill in the related art should appreciate that the insulating layers 26 can have any suitable thickness.

The frame 24 defines also a thin middle layer 28 that is sandwiched between the insulating layers 26 and acts as the conductor 28. The conductive layer 28 is made of a lower-strength material, such as metal. In an aspect of the non-limiting embodiment, the fuse 20 uses aluminum alloy 1060, H12 as the conductor 28. However it should be appreciated by those having ordinary skill in the related art that the fuse 20 can use any suitable lower-strength conductive material, in general, and metal, in particular, as the conductor 28—such as tin, lead, zinc-based alloys, and other lower-strength conductive metals.

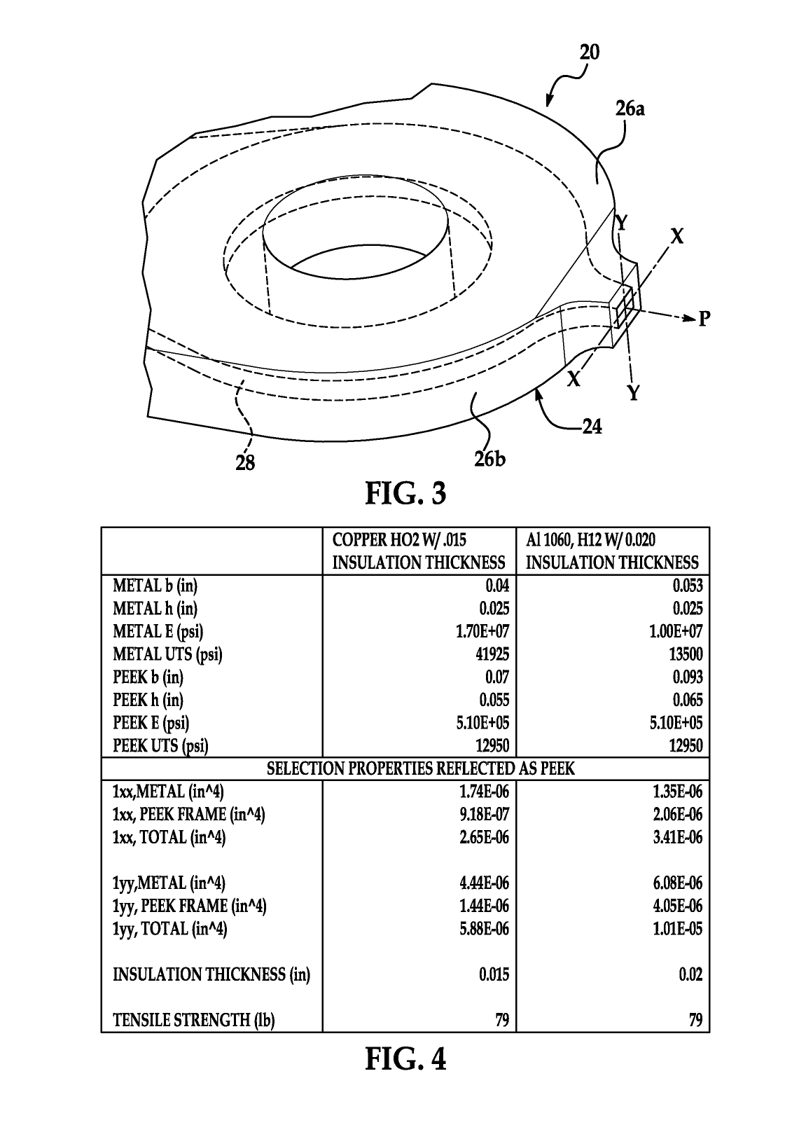

Referring now specifically to FIG. 3, a cross-section of the fuse 20 is shown. In the figure, “P” represents direction and magnitude of a tensile “fracture” load or strength of the fuse 20. In this way, the fuse 20 is loaded in tension in a direction perpendicular to “height” and “width” directions of the fuse 20.

Referring now specifically to FIG. 4, a chart compares properties of the fuse 20 with corresponding properties of an existing electromechanical fuse of a differential motion sensor. For example, according to the chart, when the conductor 28 is aluminum alloy 1060, H12 and the insulating layers 26 are about 0.020-inch thick, an “‘lxx’ section” property of the fuse 20 is increased by 29% over the same property of the existing fuse while the “‘lyy’ section” property of the fuse 20 is increased by 72% over the same property of the existing fuse. Also according to the chart, thickness of the insulating layers 26 of the fuse 20 is increased by 33% over thickness of the existing fuse. This increase translates to more durability of the fuse 20 in manufacturing, assembly, installation, and operation of the fuse 20 over those in the existing fuse. This increase also does not affect sensitivity of the fuse 10, as the fuse 20 still fractures at 79 lbs, which is the same sensitivity at which the existing fuse fractures.

The fuse 20 is a conductive link overmolded with insulation. The link is made of a lower-strength conductive material, which allows the fuse 20 to possess a larger net section. Also, the fuse 20 carries a low voltage signal, has a minimal tensile “fracture” strength, maximizes its sensitivity (including to panel skew) and “bending” strengths, reduces its dormancy, and is sufficiently durable and resistant to handling, bending and thermal stresses thereof. Furthermore, insulation of the fuse 20 is maximally thick for greater durability while maintaining the same low tensile “fracture” strength. In addition, the fuse 20 can be used in any differential-motion-sensing system. Moreover, the fuse 20 can be used as a discriminator in a larger system since the fuse 20 allows a more sensitive load to be employed, which reduces possibility of a dormant failure occurring.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various non-limiting embodiments of the invention have been described, it is to be understood that aspects of the invention may include only some of the described embodiments. Accordingly, the invention is not to be seen as limited by the foregoing description, but is only limited by the scope of the appended claims.

1. An electromechanical fuse comprising:
at least one thick layer that acts as an insulating envelope of the fuse; and
a thin layer that acts as a conductor of the fuse and is made of a lower-strength material.

2. The electromechanical fuse of claim 1, wherein the fuse comprises further an over-molded frame in which is defined the insulating and conducting layers.

3. The electromechanical fuse of claim 1, wherein thickness of the insulating layer is about 0.020 inch.

4. The electromechanical fuse of claim 1, wherein the lower-strength material is any of aluminum alloy 1060, H12; tin; lead; zinc-based alloys; and other lower-strength conductive metals.

5. The electromechanical fuse of claim 1, wherein the fuse comprises a top insulating layer and bottom insulating layer.

6. The electromechanical fuse of claim 5, wherein the conducting layer is enveloped by the insulating layers.

7. The electromechanical fuse of claim 1, wherein the fuse carries a small electrical current and is configured to fracture.

8. A differential motion sensor comprising:
an electromechanical fuse including:
at least one thick layer that acts as an insulating envelope of the fuse; and
a thin layer that acts as a conductor of the fuse and is made of a lower-strength material.

9. The differential motion sensor of claim 8, wherein the fuse comprises further an over-molded frame in which is defined the insulating and conducting layers.

10. The differential motion sensor of claim 8, wherein thickness of the insulating layer is about 0.020 inch.

11. The differential motion sensor of claim 8, wherein the lower-strength material is any of aluminum alloy 1060, H12; tin; lead; zinc-based alloys; and other lower-strength conductive metals.

12. The differential motion sensor of claim 8, wherein the fuse comprises a top insulating layer and bottom insulating layer.

13. The differential motion sensor of claim 12, wherein the conducting layer is enveloped by the insulating layers.

14. The differential motion sensor of claim 8, wherein the fuse carries a small electrical current and is configured to fracture.

15. The differential motion sensor of claim 8, wherein the sensor comprises further a pair of arms and the fuse is provided between the arms, connects the arms to each other, and holds the arms substantially stationary in normal operation of the sensor.
